(19) United States
(12) Patent Application Publication
(10) Pub. No.: US 2021/0065183 A1
(43) Pub. Date: Mar. 4, 2021

(54) COERCION-RESISTANT DIGITAL TRANSACTION ARCHITECTURE WITH FEEDBACK-BASED PROPAGATION

(71) Applicant: Bank of America Corporation, Charlotte, NC (US)

(72) Inventors: Tamara S. Kingston, Peoria, AZ (US); Monika Kapur, Jacksonville, FL (US)

(21) Appl. No.: 16/554,979

(22) Filed: Aug. 29, 2019

(51) Int. Cl. G06Q 20/40; G06Q 40/02

(52) U.S. Cl. CPC G06Q 20/407; G06Q 40/02; G06Q 20/40145

(57) ABSTRACT

Systems and methods for providing a digital transactional system with built-in coercion protection are provided. A method may include receiving, at a central server, a request to initiate an account. The account may be operable to execute a transaction. The method may include generating and storing account data. The account data may include an account number and an expiration date. The method may include selecting a lifespan mode that is included in the account data, wherein the lifespan mode may determine the expiration date and may be selected from at least two different lifespan modes. The method may include triggering, in response to a predetermined action that is executed prior to the expiration date, an extension of the expiration date.

### FIELD OF TECHNOLOGY

Aspects of the disclosure relate to digital systems. Specifically, aspects of the disclosure relate to digital transactional systems with built-in safety mechanisms.

### BACKGROUND OF THE DISCLOSURE

Digital transactional systems leverage digital technology to provide a powerful and convenient mechanism for executing transactions. Transactions may, for example, include purchases, transfers, exchanges, loans, payments, and other suitable financial transactions. A digital transactional system may be able to execute the transactions substantially instantaneously, across vast distances, and at a large scale.

Conventional digital transactional systems, however, may be associated with a number of potential vulnerabilities. One potential vulnerability may include the risk of an account or a transactional instrument being co-opted by a third party. The third party may be someone close to the primary account holder. The third party may even be an authorized user on the account. The third party may, for example, be an abusive relative or spouse who is in a position to access the account or transactional instrument with relative ease, and who may use the access to coercively execute unauthorized transactions.

It would be desirable, therefore, to provide systems and methods for digital transactional architectures. It would be further desirable for the architectures to include built-in safety mechanisms, including those that reduce the risk of transactional coercion.

### SUMMARY OF THE DISCLOSURE

Aspects of the disclosure relate to systems and methods for providing a digital transactional system with built-in coercion protection. A system may include a central server. The central server may include a processor and a memory. The central server may be configured to generate and store account data associated with a transactional account. The account data may include an account number and an expiration date.

The system may include a transactional instrument. The instrument may be associated with the account. The instrument may be operable to initiate a transaction. The transaction may be executed by the account.

The system may include a lifespan mode that is part of the account data. The lifespan mode may determine the expiration date. The lifespan mode may be selected from at least two different lifespan modes. Each of the different lifespan modes may determine a different expiration date.

The system may also include a renewal mechanism. The renewal mechanism may be configured to, in response to a predetermined action that is executed prior to the expiration date, trigger an extension of the expiration date.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows an illustrative apparatus in accordance with principles of the disclosure;

FIG. 3 shows an illustrative system architecture in accordance with principles of the disclosure;

FIG. 4 shows an illustrative screenshot in accordance with principles of the disclosure; and

FIG. 5 shows an illustrative flowchart in accordance with principles of the disclosure.

### DETAILED DESCRIPTION OF THE DISCLOSURE

Apparatus and methods for a digital transactional system with built-in coercion protection are provided. The built-in coercion protection may include mechanisms which reduce the risk of a coercive third party executing unauthorized transactions via the digital transactional system.

The system may include a central server. The central server may be physically located in one location. The central server may be logically central. The central server may be distributed. The central server may be, at least in part, cloud-based.

The central server may include a processor and a memory. The memory may be non-transitory. The system may include computer code (i.e., computer executable instructions). The code may be stored in the memory. The code may be configured to run on the processor. Running the code on the processor may implement some or all of the system elements and method steps.

The central server may be configured to generate and/or store account data associated with a transactional account. The account may, for example, be a credit card account, a checking account, or any suitable account associated with a financial service (e.g., investment, loan, mortgage, etc.).

The account data may include an account number and an expiration date. The account data may also include any other suitable information, for example, information that may be used by a digital transactional system to establish an account.

The system may include a transactional instrument. The instrument may be associated with the account. The instrument may be operable to initiate a transaction. The transaction may be executed by the account. For example, the instrument may be a credit card or a debit card. The credit or debit card may be a physical (e.g., plastic or metal) card. The credit or debit card may be a digital card, for example a card that is associated with a digital wallet, or other suitable digital application.

The credit or debit card may be operable to initiate a transaction, such as a purchase, a withdrawal, or a transfer. The transaction may be executed by the account. In some embodiments, the account may not include a transactional instrument, and the account may be configured to execute a transaction independently.

The system may include a lifespan mode. The lifespan mode may be part of the account data. The lifespan mode may determine the expiration date. The expiration date may be a date on which the account will expire. The expiration date may be a date on which the transactional instrument will expire. Expiration of the account and/or the transactional instrument may lock the account and/or the transactional instrument from being used. The account and/or the transactional instrument may be locked from use until one, two, or any suitable number of predetermined authentication actions are taken. In some embodiments, the expiration of the account and/or the transactional instrument may be irreversible.

The lifespan mode may be selected from at least two different lifespan modes. Each of the different lifespan modes may determine a different expiration date. For example, the different lifespan modes may include a standard lifespan mode and a shortened lifespan mode. The standard mode may be associated with a conventional, or other suitable non-shortened, expiration, e.g., four years from initiation of the account and/or the instrument. The shortened mode may be associated with a shortened expiration. For example, the shortened expiration may be one month, three months, six months, eight months, one year, two years, or any other suitable expiration timeframe for a shortened lifespan mode.

In certain embodiments, one of the different lifespan modes may be a default lifespan mode that, absent another selection, may be automatically selected as the lifespan mode that is part of the account data. Another one of the different lifespan modes may be a safety lifespan mode. The safety lifespan mode may be selected via an opt-in selection.

In some embodiments, the expiration date that is determined by the safety lifespan mode may be earlier than the expiration date determined by the default lifespan mode. The default lifespan mode may be the “standard” mode, and the safety lifespan mode may be the “shortened” mode. In other embodiments, an additional mode may be available that is “extended” (i.e., later expiration than the default, or standard, mode).

Providing a multi-track digital financial system, with the option to select from among different lifespan modes (e.g., a standard mode and a shortened safety mode), may address a fundamental difficulty associated with conventional digital financial systems. The difficulty may arise since a shorter lifespan (i.e., sooner expiration date) is generally less convenient, since the account may have to be renewed often. A shorter lifespan may also cause inefficiencies that may arise when an account expires due to accidental lack of renewal. A longer lifespan (i.e., later expiration date), however, may reduce the security of the system, since a compromised system may expire later, resulting in increased damage. The multi-track system may provide a tailored solution, whereby the standard mode may be selected when a low level of risk of compromise is present, while the shortened mode may be selected when a higher risk level is present.

In certain embodiments, the opt-in selection for the safety lifespan mode may reflect a manual selection by an account user. The manual selection may occur when the account user applies for the account. For example, an option may be offered, or otherwise available for selection, when a user applies for an account. Alternatively, the user may apply for a specialized “safety” account that features the safety lifespan mode. Applying for the safety account may qualify as an opt-in selection for the safety lifespan mode.

In some embodiments, the opt-in selection may be performed automatically by the system. The automatic selection may be based on a set of predetermined factors. The factors may indicate a threshold level of risk of transactional coercion. Selection of the set of predetermined factors may leverage a machine-learning (ML)-based analysis to determine factors that indicate a threshold level of risk of transactional coercion.

Exemplary factors may include a pattern of social media activity. The pattern may indicate a likelihood of an account user being at risk of an account compromise. For example, the pattern may indicate a likelihood of the account user being in an abusive relationship. Certain words or phrases, for example, may be “red flags” of an individual being abused.

Other exemplary factors may include certain patterns of financial activity. The patterns of financial activity may indicate a likelihood of an account user being subjected to coercive transactions. For example, repeated suspicious activity of a secondary cardholder on a credit card account may indicate that the secondary cardholder is executing coercive transactions that may adversely affect the account user.

Exemplary factors may also include enrollment by the account user in a program for abused individuals. Exemplary factors may also include endorsement by an authorized third party. The third party may be an acquaintance. The acquaintance may submit a request for a safety mode for the account user. The request may, in some embodiments, be subject to approval by the account user.

The system may also include a renewal mechanism. The renewal mechanism may be configured to, in response to a predetermined action that is executed prior to the expiration date, trigger an extension of the expiration date. The renewal mechanism may provide a checkpoint of sorts to ensure that the system only propagates and remains active when secure and not compromised. The predetermined actions, therefore, may preferably be chosen to provide a level of authorization. Examples of predetermined actions may include receipt of an authorized request via telephone, email, and/or an online portal, or any other suitable action that may provide authorization. In some embodiments, the renewal mechanism may only be included when a shortened lifespan mode is selected. In certain embodiments, when a standard lifespan mode is selected, the account and/or instrument may be configured to renew automatically.

The system may also, in certain embodiments, include an abort mechanism. The abort mechanism may be configured to lock, close, cancel, or otherwise incapacitate the account and/or the instrument in response to a predetermined signal. The abort mechanism may also be configured to toggle the selected lifespan mode. For example, in response to the predetermined signal, the abort mechanism may toggle the selected lifespan mode from a safety mode to a conventional mode or vice versa.

The signal may indicate that the account and/or instrument has been compromised. The signal may include selecting an option via an online portal, communicating a request or predetermined safety message/phrase via email or telephone, or any other suitable transmission of a signal to abort the account. Conversely, the signal may indicate that a risk of compromise has been reduced. For example, the system may be configured to periodically transmit a message to the account user to check on the account user's status. Receipt of a response indicating a safe status may constitute a signal to trigger the abort mechanism. In another example, an automated monitoring system may send a signal that previous patterns of activity indicating a risk of compromise have ceased. In some embodiments, the abort mechanism may only be included when certain lifespan modes are selected (e.g., a shortened or safety lifespan mode).

In some embodiments, the system may include a safety lock mechanism. The safety lock mechanism may prevent the instrument from initiating a transaction unless a predetermined authentication is achieved. The safety lock mechanism may, in certain embodiments, be activated only when the safety lifespan mode is selected.

Examples of predetermined authentication may include biometric authentication and/or entry of a predetermined passcode, personal identification number (PIN), social security number (SSN), and/or any other suitable form of authentication.

A method for reducing a risk of transactional coercion in a digital transactional system is provided. The method may include receiving, at a central server, a request to initiate an account. The account may be a credit card account or a checking account. The central server may include a processor and a memory.

The method may include generating account data. The method may also include storing the account data. The account data may be generated and/or stored at the central server. The account data may include an account number and an expiration date.

The method may include selecting a lifespan mode. The lifespan mode may be included in the account data. The lifespan mode may determine the expiration date.

The lifespan mode may be selected from at least two different lifespan modes. One of the different lifespan modes may be a default lifespan mode. Absent another selection, the default lifespan mode may be automatically selected as the lifespan mode. Another one of the different lifespan modes may be a safety lifespan mode. The safety lifespan mode may be selected as the lifespan mode via an opt-in selection.

Each of the different lifespan modes may determine a different expiration date. The expiration date determined by the safety lifespan mode may be earlier than the expiration date determined by the default lifespan mode. For example, the expiration date determined by the safety lifespan mode may create a six-month lifespan for the account.

The method may include associating a transactional instrument with the account data. The instrument may be operable to initiate a transaction. In some embodiments, the account may be operable to execute a transaction with and/or without the instrument.

The method may include triggering an extension of the expiration date. The extension may be triggered in response to a predetermined action that is executed prior to the expiration date.

In some embodiments, the method may include performing the opt-in selection manually. Manual selection may occur as part of the request to initiate the account. The method may also include performing the opt-in selection automatically. Automatic selection may be based on a set of predetermined factors. The factors may indicate a threshold level of risk of transactional coercion.

In certain embodiments, the method may include preventing the instrument and/or the account from initiating and/or executing a transaction unless a predetermined authentication is achieved.

A coercion-resistant payment instrument is provided. The instrument may be operable to initiate a transaction. Exemplary instruments may include credit and debit cards. The instrument may include associated account data. The account data may include an account number and an expiration date. The account data may be generated and/or stored by a central server that comprises a processor and a memory.

The instrument may include a lifespan mode. The lifespan mode may be a part of the account data. The lifespan mode may, at least in part, determine the expiration date.

The lifespan mode may be selected from at least two different lifespan modes. One of the different lifespan modes may be a default lifespan mode that, absent another selection, may be automatically selected as the lifespan mode. Another one of the different lifespan modes may be a safety lifespan mode that may be selected as the lifespan mode via an opt-in selection.

Each of the different lifespan modes may determine a different expiration date. For example, the expiration date determined by the safety lifespan mode may be earlier than the expiration date determined by the default lifespan mode. In one preferred embodiment, the expiration date determined by the safety lifespan mode may create a six-month lifespan for the instrument.

The instrument may include a renewal mechanism. The renewal mechanism may be configured to trigger an extension of the expiration date. The extension may be triggered in response to a predetermined action that is executed prior to the expiration date.

In some embodiments, the opt-in selection may be performed manually. Manual selection may be performed by an account user. The manual selection may be performed when the account user applies for the instrument. The opt-in selection may be performed automatically. The automatic selection may be based on a set of predetermined factors. The factors may indicate a threshold level of risk of transactional coercion.

The instrument may, in certain embodiments, include a safety lock mechanism. The safety lock mechanism may prevent the instrument from initiating a transaction unless a predetermined authentication is achieved.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

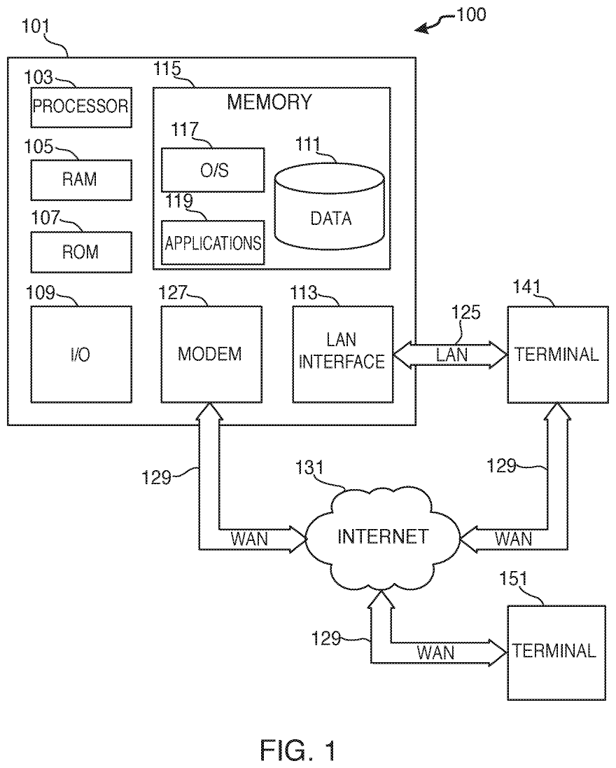

FIG. 1 shows an illustrative block diagram of system 100 that includes computer 101. Computer 101 may alternatively be referred to herein as a “server” or a “computing device.” Computer 101 may be a desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to digital transactions and/or digital financial systems. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related performing various tasks. The various tasks may be related to digital transactions and/or digital financial systems.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

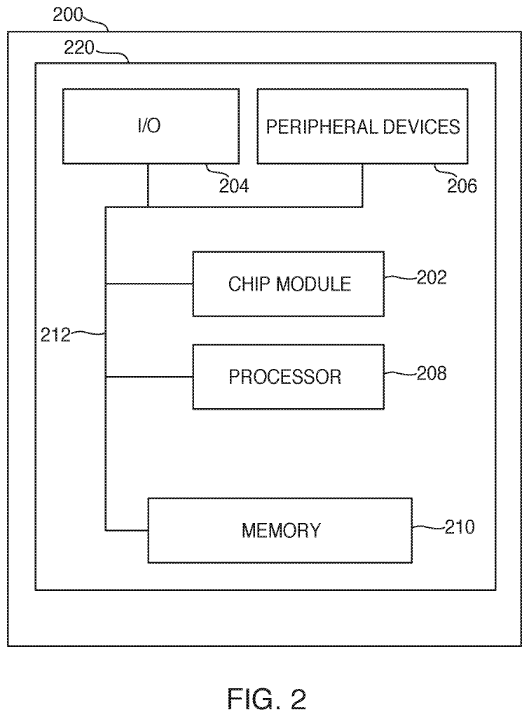

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

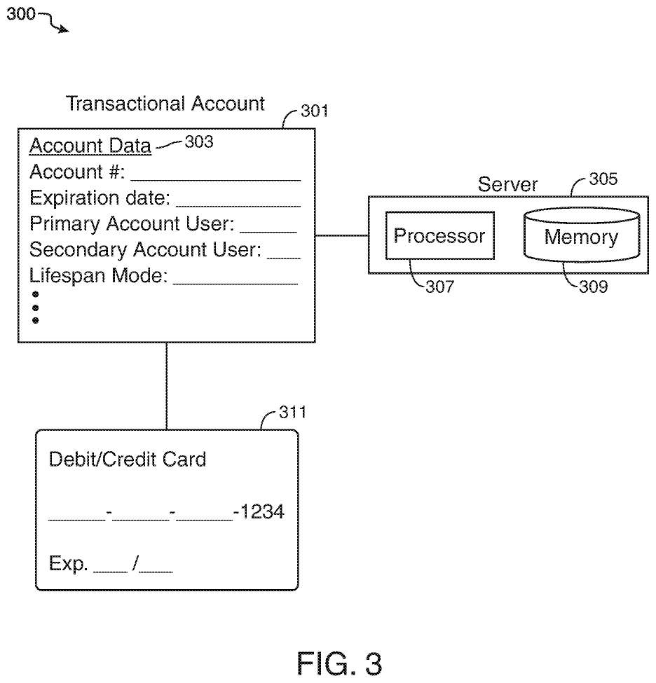

FIG. 3 shows exemplary system architecture of system 300 according to aspects of the disclosure. System 300 includes transactional account 301. Transactional account 301 may include account data 303. Account data 303 may include an account number, an expiration date, a primary account user, a secondary account user, a selected lifespan mode, and/or any other suitable information that may be useful for establishing and maintaining a transactional account.

System 300 includes server 305. Server 305 may include processor 307 and memory 309. Server 305 may be part of a network, such a network associated with a financial institution. Server 305 may include multiple processors and/or memories. Server 305 may be distributed. Server 305 may be cloud-based. Server 305 may provide some or all of the storage and processing power for system 300.

System 300 includes transaction instrument 311. Transaction instrument 311, may, for example, be a credit or debit card. Transaction instrument 311 may be associated with transactional account 301. Transaction instrument 311 may include a card number and an expiration date. The expiration date may be the same as the expiration date of account data 303. The card number may be the same as the account number of account data 303. In some embodiments, the card number may not be the same as the account number of account data 303.

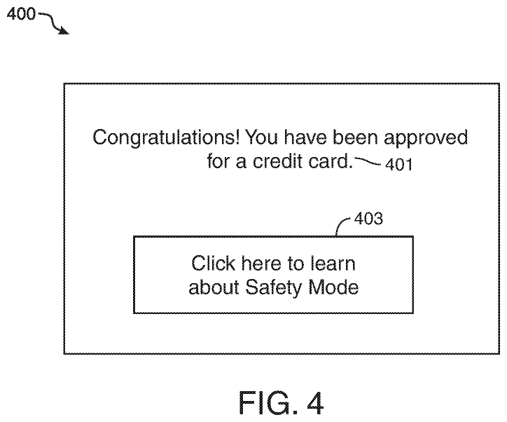

FIG. 4 shows exemplary screenshot 400 according to aspects of the disclosure. Screenshot 400 shows one exemplary embodiment of an opt-in selection to select a safety lifespan mode for an account. The particular embodiment shown in screenshot 400 may involve a mechanism for a manual opt-in subsequent to the approval of a transaction account and/or instrument. Other embodiments may include similar mechanisms, albeit in different formats, and still other embodiments may include entirely different mechanisms, such as automatic opt-in, or an implicit opt-in resulting from enrollment in a specialized account.

Screenshot 400 shows message 401. Message 401 may include any suitable message conveying to a user that an account and/or a transactional instrument has been approved. Screenshot 400 also shows selectable option 403. Selectable option 403 may display a message offering more information about a safety mode. Selecting option 403 may provide a user with information about a safety mode, and may also provide the user with the ability to select the safety mode.

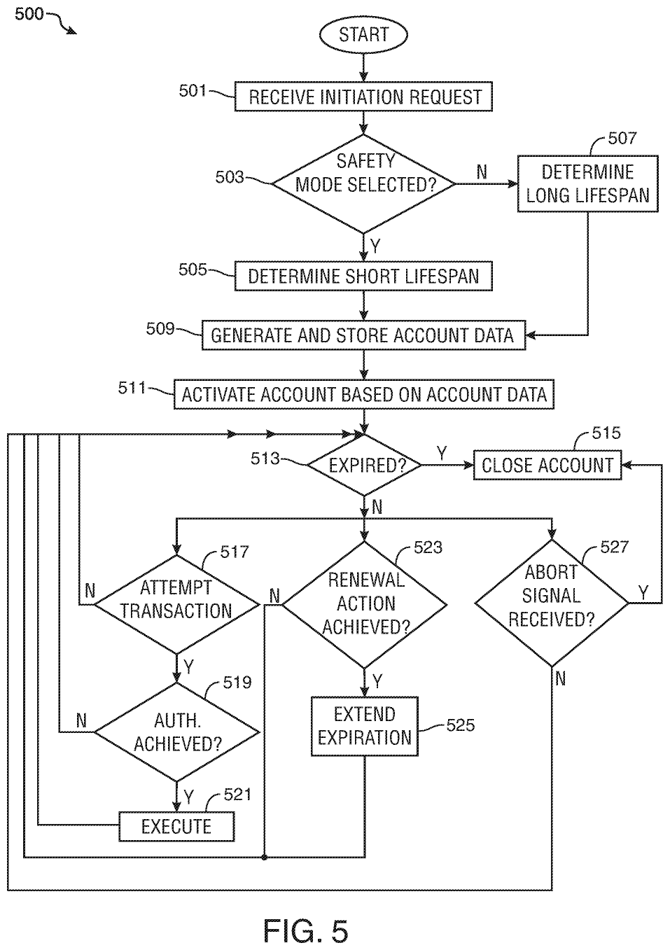

FIG. 5 shows exemplary flowchart 500 in accordance with aspects of the disclosure. Flowchart 500 shows one exemplary embodiment of a logical flow for providing a digital transactional system with built-in coercion protection. Other embodiments may include different steps and/or step sequences.

Flowchart 500 begins with receiving an initiation request at step 501. At step 503, the system checks if a safety mode is selected. If a safety mode is selected, the system may determine a short lifespan at step 505. If a safety mode is not selected, the system may determine a long (or conventional) lifespan at step 507.

Based at least in part on the determinations of steps 505 and 507, the system may generate and store account data at step 509. At step 511, the system may activate the account according to information included in the account data. At step 513, the system may check if the account is expired. If the account is expired, the system may close the account at step 515. If the account is not expired at step 513, the system may be responsive to multiple subsequent steps (e.g., 517, 523, and 527, which may run in parallel), as described in the following paragraphs.

Step 517 may check if a transaction was attempted. If no transaction was attempted, the system may loop back to step 513. If a transaction was attempted, the system may check if authentication was achieved at step 519. If authentication was not achieved, the system may loop back to step 513 without executing the transaction. If authentication was achieved, the system may execute the transaction at step 521, and then proceed to loop back to step 513.

Step 523 may check if a renewal action was received. The system may only perform step 523 within a predetermined timeframe prior to the expiration date, e.g., within two months, one month, two weeks, one week, or any other suitable timeframe. If a renewal action was received, the system may extend the expiration date at step 525. The expiration date may, in certain embodiments, be extended for the same lifespan as originally established. For example, if the account was initially established with a six-month lifespan, the expiration date may also be extended for six months in response to a renewal action. After step 525, and also if a renewal action was not received at step 523, the system may loop back to step 513.

Step 527 may check if an abort signal was received. If an abort signal was not received, the system may loop back to step 513. If an abort signal was received, the system may proceed to step 515 and close the account.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for coercion-resistant digital transaction architectures with feedback-based propagation are provided. Persons skilled in the art will appreciate that the present invention can be practiced by other than the described embodiments, which are presented for purposes of illustration rather than of limitation, and that the present invention is limited only by the claims that follow.

What is claimed is:

1. A digital transactional system with built-in coercion protection, said system comprising:
a central server comprising a processor and a memory, the central server configured to generate and store account data associated with a transactional account, said account data comprising an account number and an expiration date;
a transactional instrument associated with the account, said instrument operable to initiate a transaction that is executed by the account;
a lifespan mode that is part of the account data, wherein said lifespan mode determines the expiration date, and said lifespan mode is selected from at least two different lifespan modes, and each of the different lifespan modes determines a different expiration date; and
a renewal mechanism, said renewal mechanism that is configured to, in response to a predetermined action that is executed prior to the expiration date, trigger an extension of the expiration date.

2. The system of claim 1, wherein one of the different lifespan modes is a default lifespan mode that, absent another selection, is automatically selected as the lifespan mode, and another one of the different lifespan modes is a safety lifespan mode that is selected as the lifespan mode via an opt-in selection.

3. The system of claim 2, wherein the expiration date determined by the safety lifespan mode is earlier than the expiration date determined by the default lifespan mode.

4. The system of claim 2, wherein the opt-in selection reflects a manual selection by an account user, said manual selection that occurs when the account user applies for the account.

5. The system of claim 2, wherein the opt-in selection is performed automatically, based on a set of predetermined factors, by the system, said factors that indicate a threshold level of risk of transactional coercion.

6. The system of claim 5, wherein the set of factors include:
a pattern of social media activity that indicates a likelihood of an account user being in an abusive relationship;
a pattern of financial activity that indicates a likelihood of the account user being subjected to coercive transactions;
enrollment by the account user in a program for abused individuals; and
endorsement by an authorized third party.

7. The system of claim 1, wherein the predetermined action comprises receipt of an authorized request via telephone, email, and/or an online portal.

8. The system of claim 1, further comprising a safety lock mechanism, wherein the account is prevented from executing a transaction unless a predetermined authentication is achieved.

9. The system of claim 8, wherein the predetermined authentication comprises biometric authentication and/or entry of a predetermined passcode, personal identification number (PIN), and/or social security number (SSN).

10. The system of claim 1, further comprising an abort mechanism, wherein, in response to receipt of a predetermined signal, the account is aborted and/or the selected lifespan mode is toggled to another lifespan mode.

11. The system of claim 1, wherein the account is a credit card account or a checking account.

12. A method for reducing a risk of transactional coercion in a digital transactional system, the method comprising:
receiving, at a central server, a request to initiate an account, said central server comprising a processor and a memory, and said account operable to execute a transaction;
generating and storing, at the central server, account data, said account data comprising an account number and an expiration date;
selecting a lifespan mode that is included in the account data, wherein:
said lifespan mode determines the expiration date;
said lifespan mode is selected from at least two different lifespan modes, wherein one of the different lifespan modes is a default lifespan mode that, absent another selection, is automatically selected as the lifespan mode, and another one of the different lifespan modes is a safety lifespan mode that is selected as the lifespan mode via an opt-in selection; and
each of the different lifespan modes determine a different expiration date, wherein the expiration date determined by the safety lifespan mode is earlier than the expiration date determined by the default lifespan mode;
configuring the account to be operable to initiate a transaction; and
triggering, in response to a predetermined action that is executed prior to the expiration date, an extension of the expiration date.

13. The method of claim 12, further comprising performing the opt-in selection:
manually, as part of the request to initiate the account; or
automatically, based on a set of predetermined factors, said factors that indicate a threshold level of risk of transactional coercion.

14. The method of claim 12, further comprising preventing the account from executing a transaction unless a predetermined authentication is achieved.

15. The method of claim 12, wherein the account is a credit card account or a checking account.

16. The method of claim 12, wherein the expiration date determined by the safety lifespan mode creates a six-month lifespan for the account.

17. A coercion-resistant payment instrument, said instrument operable to initiate a transaction, and said instrument comprising:
associated account data, said account data comprising an account number and an expiration date, wherein said account data is generated and stored by a central server that comprises a processor and a memory;
a lifespan mode that is part of the account data, wherein:
said lifespan mode determines the expiration date;
said lifespan mode is selected from at least two different lifespan modes, wherein one of the different lifespan modes is a default lifespan mode that, absent another selection, is automatically selected as the lifespan mode, and another one of the different lifespan modes is a safety lifespan mode that is selected as the lifespan mode via an opt-in selection; and
each of the different lifespan modes determine a different expiration date, wherein the expiration date determined by the safety lifespan mode is earlier than the expiration date determined by the default lifespan mode; and
a renewal mechanism, said renewal mechanism that is configured to, in response to a predetermined action that is executed prior to the expiration date, trigger an extension of the expiration date.

18. The instrument of claim 17, wherein the opt-in selection is performed:
manually by an account user when the account user applies for the instrument; or
automatically, based on a set of predetermined factors, said factors that indicate a threshold level of risk of transactional coercion.

19. The instrument of claim 17, further comprising a safety lock mechanism, wherein the instrument is prevented from initiating a transaction unless a predetermined authentication is achieved.

20. The instrument of claim 17, wherein the expiration date determined by the safety lifespan mode creates a six-month lifespan for the instrument.
